(19) United States
(12) Patent Application Publication
(10) Pub. No.: US 2026/0267813 A1
(43) Pub. Date: Sep. 10, 2026

(54) Request Buffer

(71) Applicant: Arm Limited, Cambridge (GB)

(72) Inventors: Ashok Kumar Tummala, Cedar Park, TX (US); Jamshed Jalal, Austin, TX (US); Dimitrios Kaseridis, Austin, TX (US); Apurva Patel, Austin, TX (US); Sujata Gopu, Austin, TX (US)

(73) Assignee: Arm Limited, Cambridge (GB)

(21) Appl. No.: 19/547,974

(22) Filed: Feb. 24, 2026

(30) Foreign Application Priority Data
Mar. 5, 2025 (EP) 25300017.8

(51) Int. Cl. G06F 13/36

(52) U.S. Cl. CPC G06F 13/36; G06F 2213/40

(57) ABSTRACT

An integrated circuit data processing system for processing requests, comprising an interconnect system, at least one requestor; and a data processing apparatus. The interconnect system forms part of a first layer, associated with the transfer of requests. The data processing apparatus comprises an active tracker (2), a request buffer (5), and property decoding logic (11). The active tracker (2) forms part of a second layer (23), associated with the processing of requests. The property decoding logic (11) decodes at least a portion of a payload of a request stored in the request buffer to determine at least one second-layer property of the request. The apparatus determines a request to pass from the request buffer (5) to the active tracker (2) based on the at least one second-layer property. The apparatus issues credits to a requestor, wherein a credit is associated with a request-buffer-storage-element which is reserved for a request (24) from the requestor.

### TECHNICAL FIELD

The technology described herein relates to an integrated circuit data processing system for processing requests, a non-transitory computer-readable medium storing computer-readable code for fabrication of such an integrated circuit data processing system, and a data processing method for processing requests.

### BACKGROUND

The technology described herein seeks to provide an integrated circuit data processing system comprising a data processing apparatus providing improved request processing.

It is known for an integrated circuit data processing system to comprise at least one requestor and at least one data processing system coupled together via an interconnect system. It is furthermore known for such a data processing apparatus to comprise an active tracker for processing requests received from the requestors over the interconnect system.

For data processing apparatuses which receive a particularly high volume of requests, it is common for all of the entries in the active tracker to become occupied quickly, leading to requests failing and needing to be retried. This increases traffic on the interconnect system and introduces delays, effectively reducing the bandwidth of the interconnect system.

The technology described herein seeks to provide an improved data processing apparatus.

### BRIEF DESCRIPTION OF THE DRAWINGS

Embodiments of the technology described herein will now be described, by way of example only, with reference to the accompanying drawings, in which:

FIG. 1 is a schematic diagram showing an integrated circuit data processing system to which the technology described herein may be applied;

FIG. 2 is a schematic diagram of request allocation logic for nodes of the integrated circuit data processing system of FIG. 1, according to the prior art;

FIG. 3 is a schematic diagram representing transaction flow within the request allocation logic of FIG. 2, according to the prior art;

FIG. 4 is a schematic diagram of request allocation logic for nodes of the integrated circuit data processing system of FIG. 1, according to an embodiment of the technology described herein;

FIG. 5 is a flow diagram representing the various possible paths for a request flowing through the logic of FIG. 4;

FIG. 6 is a schematic diagram representing transaction flow within the request allocation logic of FIG. 4, according to an embodiment of the technology described herein; and

FIG. 7 is a flow diagram representing a data processing method according to an embodiment of the technology described herein.

### DETAILED DESCRIPTION

A first embodiment of the technology described herein comprises an integrated circuit data processing system for processing requests, comprising an interconnect system, at least one requestor, and a data processing apparatus, associated with at least one downstream resource, and coupled to the at least one requestor via the interconnect system. The data processing apparatus is configured to receive and process requests from the at least one requestor over the interconnect system. The interconnect system thereby forms part of a first layer (e.g. a link layer), the first layer associated with the transfer of requests. The data processing apparatus comprises an active tracker, configured to process requests. The active tracker thereby forms part of a second layer (e.g. the protocol layer), the second layer associated with the processing of requests. The data processing apparatus further comprises a request buffer, comprising a plurality of request-buffer-storage-elements for storing received requests which the active tracker is unavailable to process at receipt of the request, the request buffer configured to pass requests stored as entries in the request-buffer-storage-elements to the active tracker, for processing by the active tracker. The request buffer acts as a first layer buffer, configured to move requests from the interconnect system into the data processing apparatus. The data processing apparatus further comprises property decoding logic, associated with the request buffer, and configured to decode at least a portion of a payload of a request stored in the request buffer to determine at least one second-layer property of the request. The data processing apparatus is configured to determine a request to pass from the request buffer to the active tracker based on the at least one second-layer property of the request. The data processing apparatus is configured to issue credits to a requestor of the at least one requestor, wherein a credit is associated with a request-buffer-storage-element which is reserved for a request from the requestor.

A second embodiment of the technology described herein comprises a data processing method for processing requests. The method comprises receiving, by a data processing apparatus, a request over an interconnect system from a requestor, wherein an active tracker of the data processing apparatus is unavailable at receipt of the request to process the request. The interconnect system forms part of a first layer, the first layer associated with the transfer of requests. The active tracker forms part of a second layer, the second layer associated with the processing of requests. The method further comprises storing the received request as an entry in a request-buffer-storage-element of a request buffer of the data processing apparatus; decoding, using property decoding logic associated with the request buffer, at least a portion of a payload of a request stored in the request buffer to determine at least one second-layer property of the request; determining, by the data processing apparatus, a request to pass from the request buffer to the active tracker based on the at least one second-layer property of the request; based on the active tracker becoming available, passing the determined request from the request-buffer-storage-element to the active tracker; and the active tracker processing the request. The request buffer acts as a first layer buffer, configured to move requests from the interconnect system into the data processing apparatus. The method further comprises issuing, by the data processing apparatus, a credit to a requestor, the credit associated with a reserved request-buffer-storage-element.

The method according to a second embodiment of the technology described herein may be carried out by the integrated circuit data processing system according to a first embodiment of the technology described herein as described above and in greater detail below.

The request buffer is configured to pass requests which it stores to the active tracker for processing. It will be understood that in order to do so the active tracker must, at the point of passing on of the request, be available to process a request. However, it will further be understood that the availability of the active tracker (e.g. a register or storage element in the active tracker) may be a necessary but not sufficient condition for the request buffer to pass on one of its stored requests (i.e. the determined request), since the stored request may lose out to a newly received request, which may be assigned the available entry.

The request buffer stores received requests which the active tracker is unavailable to process at receipt of the request. This again may be a necessary but not sufficient condition, i.e. not all requests for which there is not space in the active tracker will be stored in the request buffer, particularly since the request buffer may be full. Furthermore, the active tracker may be unavailable since all of its resources (e.g. storage elements) are already allocated, or because the last available resource is assigned to an existing request stored in the request buffer, in favour of the newly received request, meaning that the newly received request is then passed to the request buffer, whilst a different request is passed from the buffer to the active tracker.

The active tracker processes requests, and it will therefore be understood that the active tracker may be considered as being present in the second (i.e. protocol) layer. The request buffer stores received requests (i.e. flits) and passes these to the active tracker for processing, based on certain second-layer (protocol) properties of the request, i.e. it determines of a plurality of requests which request to pass on to the active tracker from the request buffer based on the decoded properties of the plurality of requests. A flit is a flow control unit (i.e. of the link layer). The request buffer thus effectively has some understanding of the content of the flit, but does not have the capability of actually processing the request (e.g. since it decodes only a subset of all of the second-layer properties). It stores the flit, i.e. the link layer information, but it uses the protocol properties of the request which it does decode to determine how to handle the request, thereby achieving protocol-level flow control. The request buffer may therefore be considered as being present at the interface of (i.e. between) the second (protocol) layer and the first (link) layer. The request buffer may thus be referred to as a “Request Flit Credit Buffer” because a flit is the flow control digit of the link layer. The credits which are issued may be understood as protocol credits, because they are associated with protocol level flow control.

The data processing apparatus may be configured for operation according to a particular protocol (e.g. the CHI protocol). The data processing apparatus (or the request buffer) may know, based on this, which second-layer properties to decode using the property decoding logic. The request buffer therefore may be protocol-aware (i.e. since it has some understanding of some of the second-layer protocol properties).

Thus it will be seen that, in accordance with the technology described herein, by providing the request buffer and associated property decoding logic, requests which cannot be allocated to the active tracker immediately are able to be stored and subsequently passed to the active tracker for processing, reducing the need for requests to be retried. The requests are passed on based on their decoded properties, which provides improved flow control and quality of service, e.g. compared to if they were just passed on based on the order in which they were received at the buffer. Furthermore, by issuing credits for storage elements of the request buffer, rather than for the active tracker itself, the latency of a request process including the credit transmission is hidden by the request buffer, thereby reducing overall latency of the request processing.

The data processing apparatus (e.g. the request buffer, or associated logic) determines which request to pass to the request buffer based on at least one second-layer property (e.g. protocol property) of the payload of the request (i.e. a property of the request itself, decoded from the request). In some embodiments, the property decoding logic decodes a proper subset of all of the second-layer properties. Thus, the decoded at least one second-layer property of the request may be a proper subset of the second-layer properties of the request. By this it will be understood that of all of the second-layer properties which the request has overall (i.e. as defined by the particular protocol according to which the request is made), the property decoding logic decodes only some and not all of these. The request buffer is thus unable to process requests, since this would require all second-layer properties of a given request to be decoded, but it may achieve flow control based on the subset of second-layer properties of which it is aware.

The proper subset may, for example, comprise only properties associated with requests and retries, and may exclude, for example, properties associated with other channels such as data.

A second-layer property of the request will be understood as a (e.g. protocol) property belonging to the payload of the request. Examples include a request type, a source type or ID (i.e. of the requestor), or a Quality of Service value associated with the request. Thus, in some embodiments, the at least one second-layer property comprises a type of the request and/or the identity of the requestor which issued the request.

In some embodiments, the data processing apparatus (e.g. the request buffer) is configured to divide stored requests into different lists, each list corresponding to a traffic class. The traffic classes may be based on the at least one second-layer property. The data processing apparatus (e.g. the request buffer) may further be configured to determine which request to pass from the request buffer to the active tracker based on the traffic class of the request. The request buffer may be provided by a virtual FIFO (i.e. first-in-first-out data structure). This may allow separate FIFOs within the virtual FIFO to correspond to each different list or traffic class.

In some embodiments, the request buffer acts as a first (e.g. link) layer buffer, configured to move requests from the interconnect system into the data processing apparatus. The request buffer may provide a pathway for requests from the interconnect system to reach the active tracker, and may thereby provide a first layer buffer. Thus the request buffer may provide the link layer buffer. This advantageously avoids the need to also provide a (separate) link layer buffer to the data processing apparatus, or alternatively may be considered a providing a link layer buffer which has significantly improved functionality compared to known prior art link layer buffers. It will be appreciated that the request buffer may need to include a greater number of storage elements than the prior art link layer buffer, in order to provide this improved functionality (e.g. since multiple different FIFO lists are provided). Providing a buffer which provides both link layer and protocol layer functionality is unconventional, since these layers are usually separated, but it has been appreciated by the Applicant that this may achieve improved functionality and/or performance as described herein.

The data processing apparatus receives and processes requests over the interconnect system from at least one requestor. The requestor for a given data processing apparatus may be any component which is permitted (e.g. by the relevant protocol and/or or device specification, for example CHI) to send a request to the node. One or more of the types of request node described herein may provide a requestor (e.g. RNFs, RNDs, RNIs). Requestors may also be provided by IO device(s) coupled to the interconnect system via such a request node.

The data processing apparatus is associated with a downstream resource. It will be understood that the requests received over the interconnect system are requests for (i.e. directed to) the associated downstream resource. The resource may be any suitable component or region to which a request may be made. The downstream resource may be, for example, memory (e.g. on-chip or off-chip, for example where the data processing apparatus is a home node), a memory controller (e.g. where the data processing apparatus is an SNF), or a separate chip or IO controllers such as PCIe/CXL (e.g. where the data processing apparatus is a CCG).

Thus, various types of data processing apparatus (e.g. nodes) may contain the recited arrangement. In some embodiments, the data processing apparatus is a memory controller, a gateway bridge, or a home node configured to control coherency amongst data stored by the data processing system. In some embodiments, the integrated circuit data processing system may comprise at least two (optionally a plurality of) data processing apparatuses, which may be of any of the types listed above.

In some embodiments, the data processing apparatus comprises request allocation logic which comprises the active tracker, the request buffer and the property decoding logic (and optionally also the buffer credit manager and active tracker credit manager, described below). The request allocation logic (e.g. the request buffer, the buffer credit manager, the decoder logic, or a combination of these) may be configured to determine a request to pass from the request buffer to the active tracker based on the at least one second-layer property of the request.

In some embodiments, the data processing apparatus further comprises a retry module, the retry module configured to monitor failed requests which are received and not stored in either the active tracker or the request buffer, the retry module configured to issue the credits to requestors with outstanding failed requests. The retry module may also be referred to as a retry block or retry circuitry. The retry module thus tracks rejected requests and issues credits for retries, the credits relating to the request buffer (i.e. rather than the active tracker).

In some embodiments, the method further comprises receiving, by the data processing apparatus, a request over an interconnect system from a requestor, wherein the active tracker is unavailable on receipt of the request and all request-buffer-storage-elements in the request buffer are unavailable on receipt of the request, such that the request is a failed request, noting, by a retry module of the data processing apparatus, the failed request, responsive to an entry in the request-buffer-storage-element becoming available for the failed request, the retry module issuing, to the requestor associated with the failed request, a credit for the available request-buffer-storage-element and reserving the available request-buffer-storage-element, responsive to receiving the credit (i.e. to the requestor receiving the credit), receiving from the requestor a retry of the failed request, storing the received retry request as an entry in the reserved request-buffer-storage-element, based on the active tracker becoming available, passing the retry request from the request-buffer-storage-element to the active tracker, and the active tracker processing the request.

It will be understood that the method steps recited above and according to the second embodiment may be carried out with respect to two or more different requests (e.g. first and second) in accordance with the details of the method described further below, i.e. all of the recited steps need not be carried out in relation to the same request. Alternatively, the received retry request may be the stored request referenced in the method described above.

In some embodiments, the method further comprises responsive to noting, by the retry module, the failed request, the retry module sending to the requestor a failed-request-acknowledgement (i.e. before later sending a credit once a buffer storage element becomes available).

In some embodiments, the data processing apparatus further comprises a buffer credit manager, the buffer credit manager configured to receive the at least one second-layer property of a request from the property decoding logic and to arbitrate between requests (e.g. between newly received requests and requestors having outstanding failed requests based on their respective second-layer properties) to determine which request to grant a credit for a request-buffer-storage-element. The buffer credit manager may be provided by arbitration logic or arbitration circuitry.

Thus, in some embodiments, the method further comprises receiving, by a buffer credit manager, the at least one second-layer property of a request from the property decoding logic; and arbitrating, by the buffer credit manager, between a newly received request and a requestor having an outstanding failed request based on their respective second-layer properties, in determining which request to grant a credit for a request-buffer-storage-element.

In some embodiments, the data processing apparatus further comprises an active tracker credit manager, the active tracker credit manager configured to arbitrate between requests to determine which request to pass to the active tracker. The active tracker credit manager may be provided by arbitration logic or arbitration circuitry. In some embodiments, the active tracker credit manager arbitrates between newly received requests and entries in the request buffer (i.e. and not also between requests in the retry block) to determine which request to pass to the active tracker. The active tracker credit manager may receive the at least one second-layer property of a request from the property decoding logic (i.e. in order to make this determination), and/or it may be configured to decode at least a portion of a newly received request and/or a request stored in the request buffer, in order to determine at least one second-layer property of the (newly received) request(s), and it may arbitrate based on the received and/or determined respective second-layer properties. Alternatively, the property decoding logic may be configured to decode (or “pre-decode”) at least a portion of a newly received request (received by the data processing apparatus) in order to determine at least one second-layer property of the newly received requests, and it may pass this to the active tracker credit manager.

Providing both a buffer credit manager and an active tracker credit manager achieves a two-stage arbitration process, in which requests for entry into the request buffer are chosen from either new requests or requests in the retry block, whereas requests for entry into the active tracker are chosen from either new requests or requests in the request buffer. Thus, arbitration is carried out between only two groups at each stage. This provides a simplified arbitration scheme compared to if all of the requests are arbitrated together for entry into the active tracker.

In some embodiments, the request buffer comprises a plurality of active-tracker-storage-elements for storing received requests as entries in the active-tracker-storage-elements, the active tracker configured to process entries stored in the plurality of active-tracker-storage-elements. In some embodiments, the active tracker is unavailable to process a request upon receipt of the request if all active-tracker-storage-elements are unavailable (i.e. occupied) at receipt of the request. The active tracker may become available when it completes at least one outstanding (i.e. pending) request.

Storage elements as referred to herein may also be understood as registers. A particular unit of data stored in a storage element or register may be referred to as an entry. An entry may be associated with (e.g. representative of, corresponding to) a request.

The active tracker is configured to process requests. Thus the storage elements of the active tracker are each sized to allow both storage and execution of a request (i.e. including all necessary fields). In contrast, the request buffer stores requests, but does not process them. It does not itself have the capability to execute requests. Thus, in some embodiments, the request-buffer-storage-elements are smaller (i.e. narrower, less wide) than the active-tracker-storage-elements.

In some embodiments, the data processing apparatus is configured to issue the credits to a requestor in response to receiving a credit-fetch-request from a requestor, in advance of said requestor issuing a request. Thus, in addition, or alternatively, to issuing (retry) credits in response to a failed request, the data processing apparatus may issue credits in advance of a request, in response to a credit-fetch-request.

In some embodiments, the data processing apparatus receives requests on a (dedicated) request channel of the interconnect system (i.e. one of a plurality of channels). In some embodiments, the interconnect system comprises a first request channel and a second request channel, and wherein the request buffer is a first request buffer, and the active tracker further comprises a second request buffer, wherein the first request buffer stores requests received on the first request channel, and wherein the second request buffer stores requests received on the second request channel. Thus, separate buffers may be provided within the apparatus for separate request channels.

In some embodiments, the size of the request buffer (i.e. the number of storage elements, rather than the width of each storage element) is based on the round-trip time for a credit to be issued to a requestor and a corresponding request to be received across the interconnect system. It will be understood that the round-trip time may be estimated or approximated using any suitable measure indicative of the travel time for a request across the interconnect system, based generally on the size and latencies of the interconnect system. For example, the round-trip time may be considered as an average round-trip time on the interconnect system, a worst-case scenario round-trip time on the interconnect system, or an average of these. It will furthermore be understood that the size of the request buffer may be based on other parameters, in addition to this round-trip time.

A corresponding request will be understood as a request which is returned to a data processing apparatus responsive to receipt of a particular credit, and carrying or associated with that credit, i.e. a request destined to be assigned to the reserved entry in the request buffer associated with the credit.

Concepts described herein may be embodied in computer-readable code for fabrication of an apparatus that embodies the described concepts. Thus, a third embodiment of the present technology described herein comprises a non-transitory computer-readable medium storing computer-readable code for fabrication of the integrated circuit data processing system described herein above. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the technology described herein. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the technology described herein. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Features of any embodiment described herein may, wherever appropriate, be applied to any other embodiment described herein. Where reference is made to different embodiments or sets of embodiments, it should be understood that these are not necessarily distinct but may overlap. It will furthermore be understood that references made to a method comprising a step correspondingly extend to a data processing apparatus, or integrated circuit data processing system “configured to” carry out a step, and vice versa.

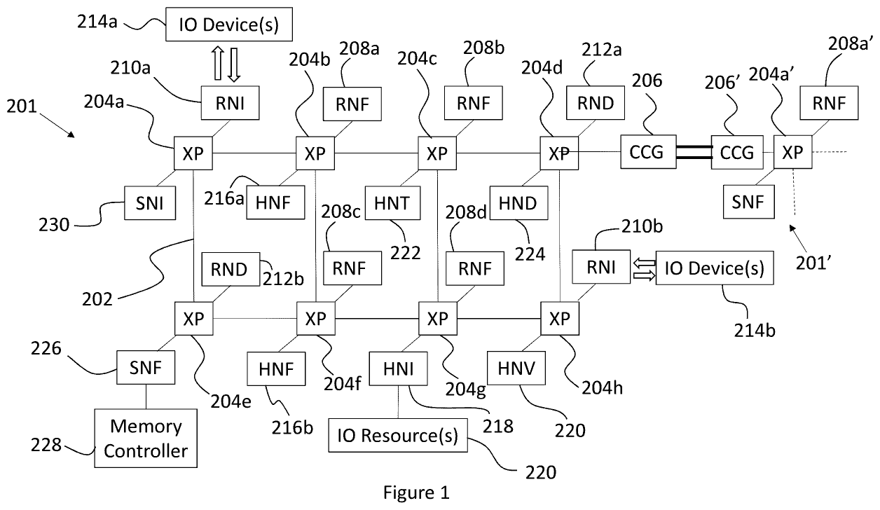

FIG. 1 is a schematic illustration of an integrated circuit data processing system 201 for processing requests. The integrated circuit data processing system 201 includes a plurality of nodes, described in further detail below. As explained below, one or more of these nodes may provide a data processing apparatus as claimed, such that the integrated circuit data processing system 201 of FIG. 1 may embody the claimed technology described herein.

The nodes are coupled together by an interconnect 202, thus forming a connection between the functional blocks which the nodes provide. The interconnect 202 provides signal connections between the nodes and may have various topologies. For example, the interconnect 202 may be configured to form a mesh network, a ring network, a cross-bar network, or other network. The interconnect may provide a number of cross-points (XPs) 204a-204h. Each cross-point 204a-204h provides one more device ports for coupling to nodes (e.g. to request nodes and home nodes as described below) and one or more interconnect ports which couple to other cross-points. Where the interconnect 202 forms a mesh network, the integrated circuit data processing system 201 may be referred to as a (coherent) mesh network 201.

Transmissions throughout the interconnect 202 are able to be sent on four channels provided by the interconnect 202-these are referred to as a Request Channel (REQ), a Response Channel (RESP), a Data Channel (DAT), and a Snoop Channel (SNP). Each of these (or only some, e.g. RESP and DAT) may be duplicated in order to provide separate channels for transmit (TX) and receive (RX). The REQ channel is used for sending read and write requests, cache maintenance requests, and DVM requests. The RESP channel is used to send completion responses for various types of messages, ranging from write and cache management responses to data-less snoop responses and operation completion acknowledgments. The SNP channel issues snoops and sends DVM operations. The DAT channel is used to send write and read data, and snoop responses which include data.

All protocol messages are sent in the form of a Flit. Flits are a packetized collection of control fields and identifiers that communicate a protocol message.

Some of the control fields sent in a Flit include opcodes, memory attributes, address, data, and error responses. Each channel needs different Flit control fields. For example, a Flit to read or write on the Request channel needs an Address field, and a Flit on the Data channel needs the Data and Byte Enable fields. The fields in a Flit may be sent in parallel (i.e. not serialized over multiple packets).

Chip-to-chip gateways (CCGs) couple between the network on one chip (i.e. one integrated circuit data processing system 201) and a network on another chip (i.e. a second integrated circuit data processing system 201′). This enables formation of a network spanning multiple chips. Two example chip-to-chip gateways 206, 206′ belonging respectively to the first and second integrated circuit data processing systems 201, 201′ are shown in FIG. 1, coupling an XP 204d of the first integrated circuit data processing system 1 to an XP 204a′ of a second integrated circuit data processing system 201′. Only a small part of the second integrated circuit data processing system 201′ is shown, as illustrated by the use of dashed lines out from the XP 204a′.

In this example, CCG nodes 206, 206′ include both a request agent (RA), for issuing requests and receiving snoops, and a home agent (HA), for receiving requests and issuing snoops.

There are three categories of node which may be present in the integrated circuit data processing system 201—these are Request Nodes (RNs), Home Nodes (HNs) and subordinate nodes (SNs). Each of these is described further below.

The role of request nodes is to generate transactions, such as read and write requests, in order to access and process data. These transactions are sent to Home Nodes (HNs).

There are several different varieties of request node, each of which is described by a corresponding term-a Fully Coherent Request Node (RNF), an input/output (I/O) Coherent Request Node (RNI), and an I/O Coherent RN with Distributed Virtual Memory (DVM) support (RND). A request node may be, for example, a central processing unit (CPU) core, a neural engine or other accelerator, or a Component Aggregation Layer that houses two or more CPU cores to be connected to one network port.

A Fully Coherent Request Node (RNF) contains coherent caches and will accept and respond to snoop messages for accessing or changing the coherency state of cached data. It will be understood that coherency refers to ensuring that all processors in the system see the same view of memory, meaning that changes to data held in the cache of one core are visible to the other cores, making it impossible for cores to see stale copies of data (the old data from before it was changed by the first core).

An I/O-Coherent Request Node (RNI) does not have a coherent cache, and cannot accept snoop messages. An I/O-Coherent Request Node with DVM support (RND) has the same functionality as an RNI and can also accept DVM messages. Example RNFs 208a-208d, 208a′, RNIs 210a, 210b, and RNDs 212a, 212b, are illustrated in the integrated circuit data processing system 201 of FIG. 1. As illustrated, the RNIs are connected to one or more IO devices 214a, 214b. Although not illustrated, it will be understood that the RNDs 212a, 212b, may also be connected to one or more IO devices.

Home Nodes (HNs) receive transactions from Request Nodes (RNs), and are responsible for ordering these requests, generating transactions to SNs (discussed below) and in some cases issuing snoops and handling DVM operations.

There are two main types of home node—fully coherent Home Nodes (HNFs), which order all requests to coherent memory and issue snoops to RN-Fs, and non-coherent Home Nodes (HNIs) which order requests that target an I/O subsystem. Both types act as a point of serialization.

The integrated circuit data processing system 201 includes a system level cache (SLC) which may reduce the number of accesses to memory and reduce the latency of data accesses. The system level cache may be distributed across a large set of home nodes in a network to share the cache capacity over all network nodes across multiple chips, in particular across the fully coherent home nodes (HNFs). The portion of a system level cache (SLC) present at a particular HNF may be referred to as a system cache group (SCG). A fully coherent home node (HNF) provides a point of coherency for a subset of system addresses and provides a cache for storing data associated with the addresses. Coherency may be provided by a snoop filter (SF) that tracks data copied to caches in the network caches. HNFs may thus comprise a system cache group (part of the system level cache) and a snoop filter. Thus, HNFs control coherency among data stored by the data processing system. Two example HNFs 216a, 216b are shown in FIG. 1. FIG. 1 also shown an example HNI 218, which is coupled to one or more I/O resources 220.

There are then further types of home node which are variations of the HNIs which have additional functionality compared to an HNI—these include HNVs, HNTs, and HNDs. An HNV is an HNI which further includes a distributed virtual memory (DVM) node. An HNT is an HN-I further including the functionality of both a DVM node and also a Debug Trace Controller (DTC). An HN-D is HN-I further including the functionality of a DVM node, a DTC, and a configuration subordinate (which is a subordinate interface for configuration register space access). FIG. 1 shows an example of each of an HNV 220, HNT 222 and HND 224.

A distributed virtual memory (DVM) node, also referred to as a DN, controls its own respective DVM domain, such that each RNF sends its DVM requests to the DN in its own domain. DVM requests are messages which request a DVM operation in order to support maintenance of the virtual memory system. The DN propagates snoops and receives corresponding responses, based on the received DVM request. As described above, DVM nodes may be present within various different types of node.

Subordinate nodes (SNs) provide access to data sources and sinks, such as memory and peripheral devices. A memory or peripheral device may be located off-chip or on-chip (i.e. as part of the integrated circuit data processing system 201, or separate from it).

There are two types of subordinate node—fully coherent subordinate nodes (SNFs) which connect to memory devices that back the coherent memory space, and non-coherent subordinate nodes (SNIs) which connect to I/O peripherals or non-coherent memory. FIG. 1 shows an example SNF 226, connected to a memory controller 228, and it shows an example SNI 230, which as explained may be connected to non-coherent memory or an I/O peripheral (not shown).

Every component in the system is assigned a Unique Node ID. The system may then use a System Address Map (SAM) to convert physical addresses to a Node ID.

To be able to determine the target Node ID of outgoing requests, each RN and HN has a corresponding system address map.

The operation of the integrated circuit data processing system 201 can be considered with respect to several different layers of operation—these include the physical layer, the link layer and the protocol layer.

The physical layer refers to the physical configuration of components and the physical data links between them, over which raw data may be transmitted between network nodes.

The link layer provides link initialization, flow-control, and link deactivation functionality. Link initialization refers to a mechanism by which the receiving device communicates link layer credits, on each channel that is present, to a transmitting device. Flow control refers to a mechanism by which the transmitting device uses link layer credits to send flits between network devices. The transmitting device uses one credit per flit. The receiving device sends these credits back to the transmitting device, one at a time, after processing each flit. Subsequent flit transfers can then occur. The link deactivation mechanism is achieved by the transmitting device sending all unused link layer credits on each channel back to the receiving device by sending corresponding link flits. The link layer thereby manages link channels to provide deadlock free switching across the network. The referenced first layer may be the link layer.

The protocol layer generates and processes requests and responses at the protocol nodes, defines the permitted cache state transitions at the protocol nodes that include caches, defines the transaction flow for each request type, and manages protocol level flow control. The referenced second layer may be the protocol layer.

Thus, the link layer is responsible for moving flits around the network, i.e. routing, but it has no understanding of the content of the flit, whereas the protocol layer “understands” the flit, and includes information to process requests—i.e. it understands what a particular flit is and knows how to process it. The interconnect 4 is part of the link layer.

Link layer properties refer to properties related to the transmission of a particular flit or request (i.e. its travel path through the interconnect system), whereas protocol properties refer to properties of the request itself, i.e. of the payload of the request.

Generally, the link layer and the protocol layer (and optionally also the other layers) are handled separately because validation of a design and maintainability are achieved more easily by doing so. According to the technology described herein, as explained further below, a request buffer is provided which operates across both the protocol layer and the link layer, by decoding some but not all of the protocol properties of a request, and it thereby goes against this accepted convention of separating the protocol and link layers and by doing so provides improved functionality as described herein.

Certain nodes have the capability to process requests. In order to do this, the nodes contain request allocation logic. Described below is a prior art request allocation logic 100, and a corresponding prior art method of processing requests. Then there is described a request allocation logic, and method of processing requests, according to the technology described herein. This request allocation logic may be present in one, some, or all of the types of nodes which have the capability to process requests—this may include a subordinate node (e.g. SNF 226) and/or an associated memory controller (e.g. memory controller 228), a gateway bridge (e.g. CCGs 206, 206′, optionally within the requesting agent of the CCG), or a home node configured to control coherency amongst data stored by the data processing system (e.g. HNFs 216a, 216b, HNIs 218, HNVs 220, HNTs 222, HNDs 224).

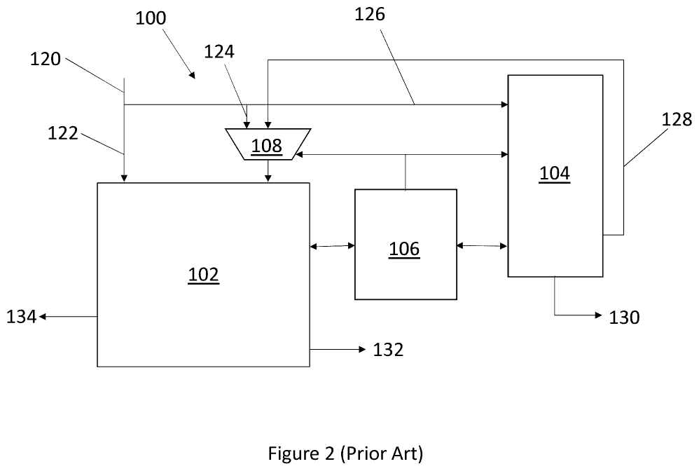

FIG. 2 shows request allocation logic 100 which may be present in a prior art arrangement of the types of nodes referred to above.

The request allocation logic 100 includes an active tracker 102, a credit manager 106 and a retry block 104. The active tracker 102 is the part of the request allocation logic which processes and fulfils received requests. It, and the associated parts which are shown, therefore all operate at the protocol level.

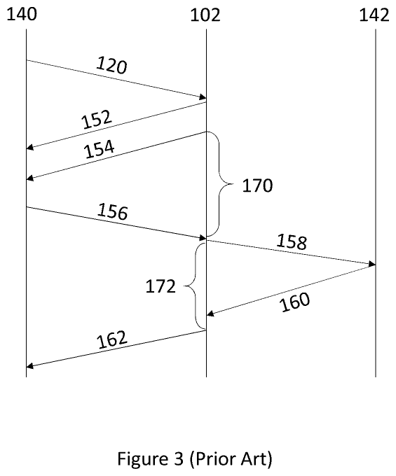

The operation of the request allocation logic 100 is described with reference to FIGS. 2 and 3.

First, a request 120 is received from a requestor 140 (shown in FIG. 3). A requestor may be any request node in the system, or any other requestor allowed by the specification which governs the system (e.g. the CHI specification) to send a request to the device containing the request allocation logic 100.

In this example, the request 120 is received from a link layer flit buffer (not shown) which is upstream of the request allocation logic 100, and which moves requests from the interconnect 4 into the particular node. The prior art link layer flit buffer is a simple FIFO (first-in-first-out) buffer, passing on requests from the interconnect 4 in order, to produce requests 120 directed towards the active tracker 102.

If there is an entry in the active tracker 102 available, the received request is sent directly to the active tracker, effectively bypassing the link layer buffer. This flow path is not shown.

The illustrated flows show the possible routes for a request where the request allocation logic 100 operates in the “retry” or “saturation mode”, which it enters upon the active tracker 102 becoming full, i.e. with no available storage elements. Once the retry mode is entered, the logic will continue to operate in the retry mode as long as there are entries stored in the retry block 104, even if entries in the active tracker 102 become available.

In this situation the flow for the received request 120 depends on whether the request is a static request (meaning that is has already been granted a credit for the active tracker 102, as explained further below), or a dynamic request, meaning it is the first time the request has been received and that it has no credit for the active tracker 102.

A static request (i.e. with a credit for the active tracker 102) follows the downwards path 122 to the active tracker. A dynamic request follows either a first path 124, to a decision point 108, if a space in the active tracker 102 is available upon receipt of the request, or follows a second path 126 to the retry block 104, if the active tracker 102 is full. The decision point 108 is managed by the credit manager 106.

If the active tracker 102 is full, then the received request is sent straight to the retry block 104. Upon receipt, the retry block 104 counts the request on the appropriate counter (e.g. based on the requestor which issued the request, and/or the request type), and issues a failed-request-acknowledgement 152 back to the requestor 140 which issued the request (as shown in FIG. 3).

Based on receiving the failed-request-acknowledgement 152, the requestor 140 knows to wait for a credit to be received and then to repeat the request only at that point. This releases the request channel, otherwise the requester might not release the request channel until the request was satisfied and this would block the request channel for an extended period.

At the first decision point 108, under the control of the credit manager 106, a choice is made between which entry to allocate to the available entry in the active tracker, either the newly received dynamic request 124 or a reserved slot for a noted failed request as represented by arrow 128. If the new dynamic request 124 is chosen, then the request is passed directly to the active tracker 102. If an entry is reserved in the active tracker 102 for a request in the retry block then as a result the retry block 104 issues a static credit 130 (also referred to as a retry credit) to the associated requester (i.e. the requester whose outstanding request now has an entry reserved). This is represented by transaction 154 in FIG. 3.

Once a device receives a static credit 130, it issues a new request, in response to the credit, which is a repeat of its earlier failed response, but now effectively carrying the issued credit. This credited request is represented by the second transaction 156 from the requestor 140 to the active tracker 102. A credited request is also referred to as a static request, and it holds a credit for the active tracker such that when it is received it follows the downwards path 122 directly to the active tracker 102.

There is thus a period of time 170 for which the storage element in the active tracker 102 is reserved, since the static credit has been issued at the time when the transaction 154 is issued, but the entry is inactive, until the new, credited request 156 is received. This first latency period 170 is a period of time in which an entry in the active tracker is “wasted”, since it is reserved but unoccupied so cannot be used for processing a request. This first latency period 170 effectively reduces the capacity of the active tracker.

Once a request is actually stored in its allocated storage element of the active tracker 102, the active tracker makes outputs 132 to chip-to-chip gateways (CCGs) and Compute Express Link (CXLs) in order to service requests and ultimately outputs responses 134, in reply to requests once they are completed. The output 132 to a downstream requested resource or region (e.g. of memory) 142 are represented by transaction 158 in FIG. 3. The responses received back from the downstream requested resource or region 142 are represented as transaction 160 in FIG. 3, and the final response (e.g. completion signal) 134 transmitted back to the requestor 140 is represented as transaction 162 in FIG. 3.

The time for request to pass from active tracker 102, on to receiver 142, and then for the response to be received, represents an overall time period 172 (i.e. second latency period) related to the round-trip latency of the mesh network. The active tracker 102 in the prior art arrangement must be sized to account for both of these latency periods 170, 172, in order to avoid negatively impacting bandwidth of the device, which is very expensive to achieve in terms of resources, since the active tracker storage elements must be large in order to facilitate request processing.

Entries in the active tracker are referred to as “expensive” because the tracker cannot be implemented with RAM since it requires many read and write ports, and since the read and write transactions through these ports must have a minimum latency. The tracker requires many read and write ports because different phases of a given transaction use information from the active tracker, and this requires each of the transaction handling phases to work simultaneously on the active tracker. These transaction handling phases include request allocation, request dispatch, response allocation, response dispatch, data dispatch etc.

Devices which receive a high number of requests, e.g. particularly CCGs and certain HNFs, can quickly go into saturation, meaning requests must be retried. The credit and retry process is undesirable since it results in two extra replies and one extra request, significantly increasing traffic on the interconnect system. The technology described herein seeks to address some of these shortcomings.

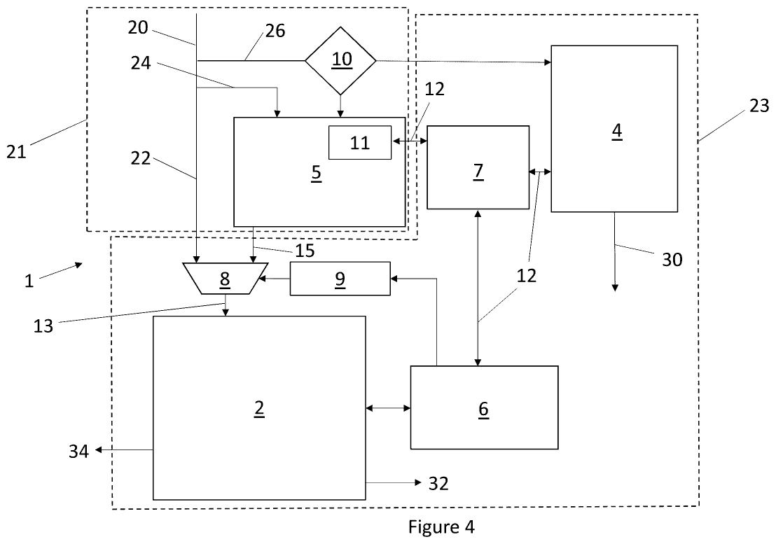

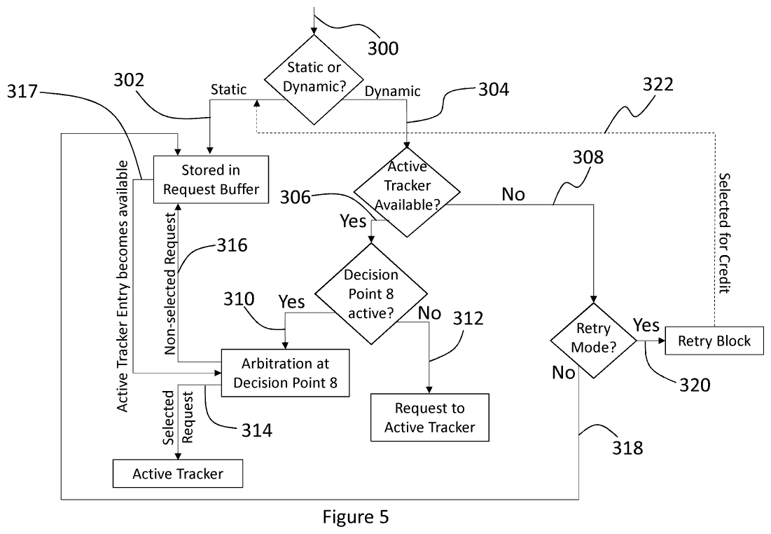

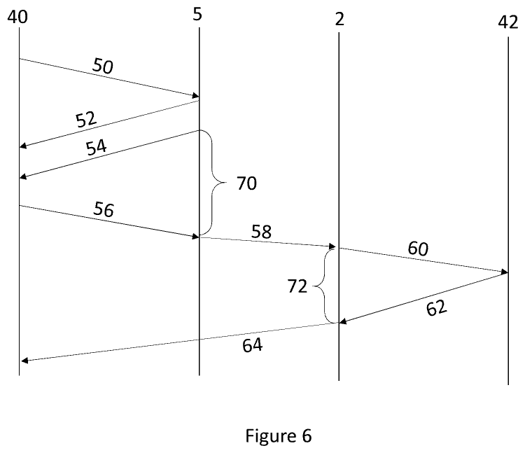

FIG. 4 shows request allocation logic 1 in accordance with the technology described herein. FIG. 5 is a flow diagram representing the various possible paths for a request flowing through the logic of FIG. 4. FIG. 6 is a schematic diagram representing a possible transaction flow within the request allocation logic of FIG. 5.

The request allocation logic 1 again includes an active tracker 2, which processes and fulfils requests, and a retry block 4 (also referred to as a retry module). According to the technology described herein, the request allocation logic 1 further includes a request (credit) buffer 5.

The request buffer 5 is sized to store requests (i.e. flits), but not to process them-its storage elements (i.e. registers) are therefore smaller, i.e. less wide than those of the active tracker 2. Effectively, the active tracker entries need to store and track a lot more decoded information than the request buffer entries, meaning that they must be wider. The request buffer 5 receives and stores only the request flits, and it does not process them, and it is therefore, on the input side, considered as being within the link layer 21. In fact, in an embodiment, the request buffer 5 provides the link layer buffer of the node which it is within, meaning that it facilitates flow of the requests from the interconnect system 4 into the node itself. It therefore effectively represents a link layer buffer having improved functionality compared to known link layer buffers.

However, the request buffer 5 includes property decoding logic 11, which decodes at least part (optionally all) of a payload of a request stored in the request buffer 5, in order to determine at least one second-layer property of the request, i.e. a protocol property, such as a Quality of Service value of the request, and/or a source type or source ID of the issuing requestor 40 (seen in FIG. 6). The request buffer 5, and associated components, then control the flow of the requests based on the decoded property information (e.g. which requests to give a credit to and/or which request to pass on from the request buffer to the active tracker). As a result of this behaviour the request buffer 5, at least at its output, is considered as being part of, or at the interface with, the protocol layer 23, which includes the active tracker 2 and the retry block 4, and other components as shown in FIG. 4.

In particular, the request buffer 5 uses the decoded property information to classify incoming requests into different traffic classes based this information. This effectively provides a prioritised list of requests, and so identifies a next request 15 to arbitrate against incoming requests for passing to the active tracker 2. The resulting prioritised list is based on the second-layer property information rather than being based (only) on the order in which requests are received, although this may also be taken into account in determining the ordering.

The protocol decoding logic 11 is configured to provide this second-layer property information 12 (i.e. protocol information) to a buffer credit manager 7, which provides it to the retry block 4, and also to an active tracker credit manager 6.

The buffer credit manager 7 and the active tracker credit manager 6 together control the flow of requests within the request allocation logic 1, as described in further detail below.

A new incoming request 20 (e.g. a CHI request) is received by the request allocation logic 1 from a requestor 40. This is represented as arrow 300 in FIG. 5. A requestor may be any request node in the system.

As above, the received request will be either dynamic (uncredited) or static (credited). These two possible routes, for a static request 302 and a dynamic request 304 are seen in FIG. 5. A dynamic request follows either the path 22, if a storage element in the active tracker 2 is available (corresponding to path 306 in FIG. 5), or a path 26, if the active tracker is unavailable (corresponding to path 308 in FIG. 5).

On path 22, there is a decision point 8. The decision point 8 is active (i.e. as shown on path 310) if either the active tracker 2 is full and/or the request buffer 5 contains at least one entry (i.e. is not empty). It is activated (or deactivated) based on an input 9 from the active tracker credit manager 6, indicating whether either of these conditions is true. If the decision point 8 is inactive, then the dynamic request 22 is passed directly to the active tracker 2, as shown on path 312 of FIG. 5.

If the decision point 8 is active, then it arbitrates, under the control of the active tracker credit manager 6, to determine which request 13 to accept into the active tracker 2 the newly received dynamic request 22 or one of the requests in the request credit buffer 5 (specifically the highest priority request 15 in the request buffer 5, i.e. the top of the list). This route is shown as arrow 314 of FIG. 5. Thus, depending on the decoded protocol properties of the two requests, the newly received dynamic request 22 may bypass the request credit buffer 5, even when it still contains entries, or it may not. In effect, the active tracker credit manager may decode certain second-layer properties of a newly received request (e.g. its class or which queue of the request buffer it should be placed in) and, if the appropriate queue of the request buffer is empty, the newly received request may bypass the request buffer and be passed directly to the active tracker.

If the new dynamic request is not accepted to the active tracker 2 (and there are entries available in the new request credit buffer 5) then the new request is stored in a storage element of the request credit buffer 5 (as shown on path 316), and then when appropriate (i.e. when decided by the active tracker credit manager 6), the request is assigned an entry in the active tracker 2 and is executed-by re-arbitrating as shown in path 317 of FIG. 5. This is achieved without the need to issue a credit to the requester and receive a new request.

If there are no spaces available in the active tracker 2, then the new dynamic request 20 instead travels the right-hand path 26, as represented at path 308. The path of the request then depends on whether or not the request allocation logic 1 operates in the retry (or saturation) mode, as indicated at decision diamond 10. If the request allocation logic 1 does not operate in retry mode (path 318), then space is available in the request buffer 5, and the dynamic request is stored in a storage element there.

If the request buffer 5 becomes full, the request allocation logic 1 enters the retry mode, meaning that incoming requests travel to the retry block 4 (path 320). Once the retry mode is entered, the logic will continue to operate in the retry mode as long as there are entries stored in the retry block 4, even if entries in the request credit buffer 5 become available.

Upon receipt of a request, the retry block 4 counts the request on the appropriate counter (e.g. based on the requestor which issued the request, and/or the request type), and issues a failed-request-acknowledgement 52 back to the requestor 40 which issued the request (as shown in FIG. 6).

The buffer credit manager 7 decides which of the requests recorded (i.e. but not stored) in the retry block 4 to issue a credit 30 for an entry in the request buffer 5 when one becomes available. For newly received requests, in the retry mode a choice is made at decision point 10, under the control of the buffer credit manager 7, of whether to allocate to an available storage element in the request credit buffer 5 to the newly received dynamic request 26 or whether to reserve a storage element for the selected previously failed request monitored by the retry block 4. This arbitration is based on the decoded protocol properties 12 of the respective requests.

If an entry is reserved in the request credit buffer 5 for a static request in the retry block 4 then as a result the retry block 4 issues a static credit 30 to the associated requester 40 (i.e. the requester whose outstanding request now has an entry reserved). This retry transmission is presented by a transaction 54 in FIG. 6.

In response to the requestor 40 receiving the credit 30, it issues a credited (static) request 56 back to the request allocation logic 1. A static request is sent straight to the request credit buffer 5, as illustrated by the second pathway 24 in FIG. 4. A static request may arise not only from a retry process, as described above, but, additionally or alternatively, the request allocation logic 1 may facilitate a process whereby a requestor may “pre-fetch” a credit, so it may request a credit ahead of time, before making the associated request. Such a credited response will then follow the same pathway 22 as a response holding a “retry” credit as described. This overall retry process is represented by a single dashed arrow 322 in FIG. 5.

There is thus a period of time 70 for which the entry in the request buffer 5 is reserved, since the static credit has been issued at the time when the transaction 54 is issued, but the entry is inactive, until the new, credited request 56 is received. The request buffer 5 may be sized (i.e. the total number of storage elements or registers is selected) to accommodate the length of this period of time 70 between issuing of retry credit 54 and receipt of a static request 56. Since an entry is reserved in the request buffer 5 rather than the active tracker 2, the latency due to this period of time 70 is partially (or possibly even fully) hidden from the perspective of the requesters 40.

As shown by transaction 58 in FIG. 6, this entry in the request buffer 5 will be passed to the active tracker 2 at the appropriate time as determined by the active tracker credit manager 6.

From the active tracker 2, the request is passed on to the requested resource or region, which is referred to as the receiver 42 (i.e. receiver of the request), in a transaction 60, as shown in FIG. 6. The active tracker makes outputs 32 to chip-to-chip gateways (CCGs) and Compute Express Link (CXLs) in order to service requests and ultimately outputs responses 34, in reply to requests once they are completed. The output 32 to a downstream requested resource or region (e.g. of memory) 42 are represented by transaction 60 in FIG. 6. The responses received back from the downstream requested resource or region 42 are represented as transaction 62 in FIG. 6, and the final response (e.g. completion signal) 34 transmitted back to the requestor 40 is represented as transaction 64 in FIG. 6.

The time for request to pass from active tracker 2, on to receiver 42, and then for the response to be received, represents a second time period 72 (i.e. second latency period) related to the round-trip latency of the mesh network. The active tracker 2 according to the technology described herein must only be sized to account for this second latency period 72, due to the presence of the request buffer.

The request buffer 5 achieves significant advantages compared to the prior art arrangement described above. It is sized to store the requests so that they can be passed directly to the active tracker 2 without a retry, thus reducing retries and therefore reducing traffic on the interconnect system. It hides (some or all) of the latency of the retry request, since an entry in the active tracker is not reserved in this retry credit period, as described above. It may replace the existing link layer buffer, thus requiring relatively little in terms of additional resources. Together these features achieve significant bandwidth improvement for a node, without having to increase the size of the active tracker which would be significantly more expensive than providing the described request buffer.

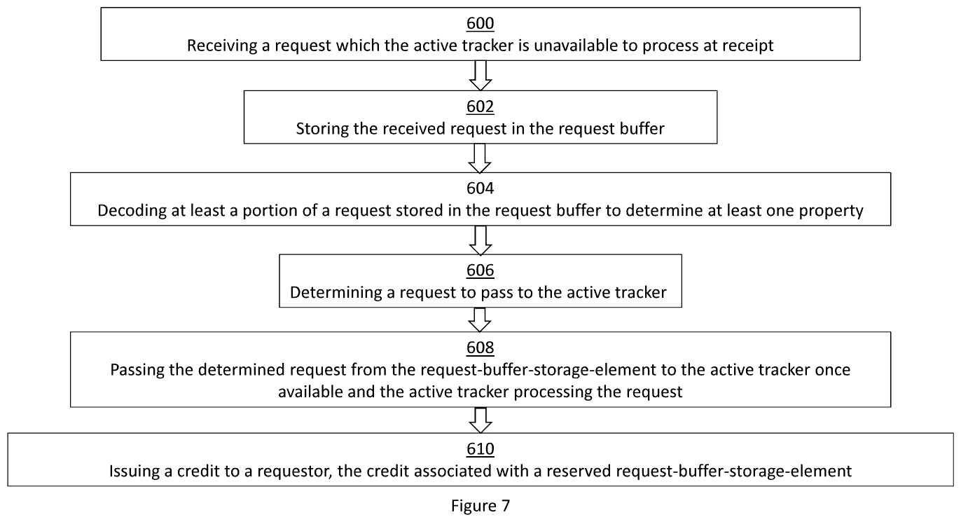

FIG. 7 is a flow diagram illustrating a data processing method according to an embodiment of the technology described herein.

The method includes a first step, 600, of receiving, by a data processing apparatus, a request over an interconnect system from a requestor, wherein an active tracker of the data processing apparatus is unavailable at receipt of the request to process the request.

The method further includes a second step, 602, of storing the received request as an entry in a request-buffer-storage-element of a request buffer of the data processing apparatus.

The method also includes a third step 604, of decoding, using property decoding logic associated with the request buffer, at least a portion of a request stored in the request buffer to determine at least one second-layer property of the request.

The method also includes a fourth step 606, of determining, by the data processing apparatus, a request to pass from the request buffer to the active tracker based on the at least one second-layer property of the request.

The method also includes a fifth step 608 of passing the determined request from the request-buffer-storage-element to the active tracker based on the active tracker becoming available, and the active tracker processing the request.

The method also includes a sixth step 610 of issuing, by the data processing apparatus, a credit to a requestor, the credit associated with a reserved request-buffer-storage-element. It will be understood that this step may take place at various points in time relative to the other illustrated method steps. For example, it may take place before step 600, e.g. for a pre-fetch credit or it may take place between steps 600 and 602, e.g. for a retry credit, i.e. such that in either case the received request is a credited request. Alternatively, it may take place in relation to a different request to the request referenced in steps 600-608.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An integrated circuit data processing system for processing requests, comprising:
an interconnect system;
at least one requestor;
a data processing apparatus, associated with at least one downstream resource, and coupled to the at least one requestor via the interconnect system, wherein the data processing apparatus is configured to receive and process requests from the at least one requestor over the interconnect system;
the interconnect system thereby forming part of a first layer, the first layer associated with the transfer of requests;
the data processing apparatus comprising:
an active tracker, configured to process requests, the active tracker thereby forming part of a second layer, the second layer associated with the processing of requests;
a request buffer, comprising a plurality of request-buffer-storage-elements for storing received requests which the active tracker is unavailable to process at receipt of the request, the request buffer configured to pass requests stored as entries in the request-buffer-storage-elements to the active tracker, for processing by the active tracker, wherein the request buffer acts as a first layer buffer, configured to move requests from the interconnect system into the data processing apparatus; and
property decoding logic, associated with the request buffer, and configured to decode at least a portion of a payload of a request stored in the request buffer to determine at least one second-layer property of the request, wherein the data processing apparatus is configured to determine a request to pass from the request buffer to the active tracker based on the at least one second-layer property of the request;
wherein the data processing apparatus is configured to issue credits to a requestor of the at least one requestor, wherein a credit is associated with a request-buffer-storage-element which is reserved for a request from the requestor.

2. The integrated circuit data processing system of claim 1, wherein the data processing apparatus further comprises a retry module, the retry module configured to monitor failed requests which are received and not stored in either the active tracker or the request buffer, the retry module configured to issue the credits to requestors with outstanding failed requests.

3. The integrated circuit data processing system of claim 2, wherein the data processing apparatus further comprises a buffer credit manager, the buffer credit manager configured to receive the at least one second-layer property of a request from the property decoding logic and to arbitrate between newly received requests and requestors having outstanding failed requests based on their respective second-layer properties, in determining which request to grant a credit for a request-buffer-storage-element.

4. The integrated circuit data processing system of claim 1, wherein the data processing apparatus further comprises an active tracker credit manager, the active tracker credit manager configured to arbitrate between requests to determine which request to pass to the active tracker.

5. The integrated circuit data processing system of claim 4, wherein the active tracker credit manager arbitrates between newly received requests and entries in the request buffer to determine which request to pass to the active tracker.

6. The integrated circuit data processing system of claim 1, wherein the at least one second-layer property comprises a type of the request.

7. The integrated circuit data processing system of claim 1, wherein the at least one second-layer property comprises the identity of the requestor which issued the request.

8. The integrated circuit data processing system of claim 1, wherein the data processing apparatus is configured to:
divide stored requests into different lists, each list corresponding to a different traffic class, the traffic classes based on the at least one second-layer property; and
to determine which request to pass from the request buffer to the active tracker based on the traffic class of the request.

9. The integrated circuit data processing system of claim 1, wherein the decoded at least one second-layer property of the request is a proper subset of the second-layer properties of the request.

10. The integrated circuit data processing system of claim 1, wherein the request buffer comprises a plurality of active-tracker-storage-elements for storing received requests as entries in the active-tracker-storage-elements, the active tracker configured to process entries stored in the plurality of active-tracker-storage-elements, and wherein the active tracker is unavailable to process a request upon receipt of the request if all active-tracker-storage-elements are unavailable at receipt of the request.

11. The integrated circuit data processing system of claim 10, wherein the request-buffer-storage-elements are smaller than the active-tracker-storage-elements.

12. The integrated circuit data processing system of claim 1, wherein the data processing apparatus is configured to issue the credits to a requestor in response to receiving a credit-fetch-request from a requestor, in advance of said requestor issuing a request.

13. The integrated circuit data processing system of claim 1, wherein the interconnect system comprises a first request channel and a second request channel, and wherein the request buffer is a first request buffer, and the active tracker further comprises a second request buffer, wherein the first request buffer stores requests received on the first request channel, and wherein the second request buffer stores requests received on the second request channel.

14. The integrated circuit data processing system of claim 1, wherein the data processing apparatus is a memory controller, a gateway bridge, or a home node configured to control coherency amongst data stored by the data processing system.

15. The integrated circuit data processing system of claim 1, wherein the size of the request buffer is based on the round-trip time for a credit to be issued to a requestor and a corresponding request to be received across the interconnect system.

16. A non-transitory computer-readable medium storing computer-readable code for fabrication of an integrated circuit data processing system for processing requests, comprising:
an interconnect system;
at least one requestor;
a data processing apparatus, associated with at least one downstream resource, and coupled to the at least one requestor via the interconnect system, wherein the data processing apparatus is configured to receive and process requests from the at least one requestor over the interconnect system;
the interconnect system thereby forming part of a first layer, the first layer associated with the transfer of requests;
the data processing apparatus comprising:
an active tracker, configured to process requests, the active tracker thereby forming part of a second layer, the second layer associated with the processing of requests;
a request buffer, comprising a plurality of request-buffer-storage-elements for storing received requests which the active tracker is unavailable to process at receipt of the request, the request buffer configured to pass requests stored as entries in the request-buffer-storage-elements to the active tracker, for processing by the active tracker, wherein the request buffer acts as a first layer buffer, configured to move requests from the interconnect system into the data processing apparatus; and
property decoding logic, associated with the request buffer, and configured to decode at least a portion of a payload of a request stored in the request buffer to determine at least one second-layer property of the request, wherein the data processing apparatus is configured to determine a request to pass from the request buffer to the active tracker based on the at least one second-layer property of the request;
wherein the data processing apparatus is configured to issue credits to a requestor of the at least one requestor, wherein a credit is associated with a request-buffer-storage-element which is reserved for a request from the requestor.

17. A data processing method for processing requests comprising:
receiving, by a data processing apparatus, a request over an interconnect system from a requestor, wherein an active tracker of the data processing apparatus is unavailable at receipt of the request to process the request, the interconnect system forming part of a first layer, the first layer associated with the transfer of requests and the active tracker forming part of a second layer, the second layer associated with the processing of requests;
storing the received request as an entry in a request-buffer-storage-element of a request buffer of the data processing apparatus, the request buffer acting as a first layer buffer, configured to move requests from the interconnect system into the data processing apparatus;
decoding, using property decoding logic associated with the request buffer, at least a portion of a payload of a request stored in the request buffer to determine at least one second-layer property of the request;
determining, by the data processing apparatus, a request to pass from the request buffer to the active tracker based on the at least one second-layer property of the request;
based on the active tracker becoming available, passing the determined request from the request-buffer-storage-element to the active tracker; and
the active tracker processing the request;
the method further comprising issuing, by the data processing apparatus, a credit to a requestor, the credit associated with a reserved request-buffer-storage-element.

18. The method of claim 17, further comprising:
receiving, by the data processing apparatus, a request over an interconnect system from a requestor, wherein the active tracker is unavailable on receipt of the request and all request-buffer-storage-elements in the request buffer are unavailable on receipt of the request, such that the request is a failed request;
noting, by a retry module of the data processing apparatus, the failed request;
responsive to an entry in the request-buffer-storage-element becoming available for the failed request, the retry module issuing, to the requestor associated with the failed request, a credit for the available request-buffer-storage-element and reserving the available request-buffer-storage-element;
responsive to receiving the credit, receiving from the requestor a retry of the failed request;
storing the received retry request as an entry in the reserved request-buffer-storage-element;
based on the active tracker becoming available, passing the retry request from the request-buffer-storage-element to the active tracker; and
the active tracker processing the request.

19. The method of claim 17, further comprising:
receiving, by a buffer credit manager, the at least one second-layer property of a request from the property decoding logic; and
arbitrating, by the buffer credit manager, between a newly received request and a requestor having an outstanding failed request based on their respective second-layer properties, in determining which request to grant a credit for a request-buffer-storage-element.

20. The method of claim 17, wherein the at least one second-layer property comprises a type of the request and/or the identity of the requestor from which the request was received.
